(19) United States
(12) Patent Application Publication
(10) Pub. No.: US 2021/0097325 A1
(43) Pub. Date: Apr. 1, 2021

(54) METHOD AND APPARATUS FOR SEGMENTING IMAGE, AND METHOD AND APPARATUS FOR TRAINING SEGMENTATION NETWORK

(71) Applicant: Beijing Sensetime Technology Development Co., Ltd., Beijing (CN)

(72) Inventors: Chao TIAN, Beijing (CN); Cong LI, Beijing (CN); Jianping SHI, Beijing (CN)

(21) Appl. No.: 17/121,670

(22) Filed: Dec. 14, 2020

Related U.S. Application Data
(63) Continuation of application No. PCT/CN2019/091328, filed on Jun. 14, 2019.

(30) Foreign Application Priority Data
Jun. 15, 2018 (CN) 201810623306.0

(51) Int. Cl. G06K 9/34; G06K 9/00; G06K 9/46; G06K 9/62; G06T 7/11

(52) U.S. Cl. CPC G06K 9/342; G06K 9/00651; G06K 9/46; G06K 9/629; G06T 2207/20084; G06T 7/11; G06T 2207/20132; G06T 2207/20081; G06K 9/6256

(57) ABSTRACT

A method of segmenting image, comprises: obtaining an image feature output from each of a plurality of processing blocks by performing a feature extraction on an image with the plurality of processing blocks; obtaining a target image feature by performing at least two stages of fusion on the image features output from at least two adjacent-processing-blocks pairs of the plurality of processing blocks; and determining a segmentation result for an object in the image according to the target image feature. An electronic apparatus for segmenting image, a method and an electronic apparatus for training a land segmentation neural network are further disclosed.

### CROSS REFERENCES TO RELATED APPLICATIONS

The present application is a continuation application of International Patent application No. PCT/CN2019/091328 filed with the China National Intellectual Property Administration (CNIPA) on Jun. 14, 2019, which is based on and claims the priority to and benefit of Chinese Patent Application No. 201810623306.0, filed with the CNIPA on Jun. 15, 2018, and entitled with “IMAGE SEGMENTATION AND SEGMENTATION NETWORK TRAINING METHOD AND APPARATUS, DEVICE, MEDIUM, AND PRODUCT.” The contents of all of the above-identified applications are incorporated herein by reference in their entirety.

### TECHNICAL FIELD

The present disclosure relates to methods and apparatuses for segmenting image, and methods and apparatuses for training segmentation network.

### BACKGROUND

With the rapid development of remote sensing satellites, remote sensing images have also begun to be applied in various fields. Because the scene of satellite remote sensing images is relatively large, has no clear boundary and has no exact structure information, segmentation scenes of the remote sensing image and the traditional image are different. This leads to some difficulties in segmenting remote sensing image with conventional neural networks, and the effect of segmentation is poor and to be improved.

### SUMMARY

The embodiments of the present disclosure provide methods and apparatuses for segmenting image, and methods and apparatuses training segmentation network.

According to one aspect of the present disclosure, a method of segmenting image is provided, including: obtaining an image feature output from each of a plurality of processing blocks by performing a feature extraction on an image with the plurality of processing blocks; obtaining a target image feature by performing at least two stages of fusion on the image features output from at least two adjacent-processing-blocks pairs of the plurality of processing blocks; and determining a segmentation result of an object in the image according to the target image feature.

In some embodiments of the present disclosure, obtaining the target image feature by performing at least two stages of fusion on the image features output from at least two adjacent-processing-blocks pairs of the plurality of processing blocks includes: obtaining a first fusion feature by performing a first-stage-fusion on the image features output from each adjacent-processing-blocks pair; obtaining one or more second fusion features by performing a second-stage fusion on at least one adjacent-first-fusion-feature pair of the first fusion features; and determining the target image feature according to the one or more second fusion features.

In some embodiments of the present disclosure, determining the target image feature according to the one or more second fusion features includes: performing a subsequent fusion on the one or more second fusion features until a number of subsequent fusion feature obtained from the subsequent fusion is one; and taking the one subsequent fusion feature as the target image feature.

In some embodiments of the present disclosure, the image features output from each adjacent-processing-blocks pair are added element-wisely during performing a fusion on the image features output from each adjacent-processing-blocks pair.

In some embodiments of the present disclosure, the plurality of processing blocks are connected in sequence; and/or, the image features output from each adjacent-processing-blocks pair have a same size and a same number of channels.

In some embodiments of the present disclosure, each of the plurality of processing blocks comprises at least one processing unit, each of which comprises at least one feature extracting layer and at least one feature adjusting layer; and obtaining the image feature output from each of the plurality of processing blocks by performing a feature extraction on the image with the plurality of processing blocks includes: obtaining a first feature by performing a feature extraction on input of the processing block with the at least one feature extracting layer of the processing block; and obtaining the image feature output from the processing block by performing an adjustment on the first feature with the feature adjusting layer of the processing block.

In some embodiments of the present disclosure, before obtaining the target image feature by performing at least two stages of fusion on the image features output from at least two adjacent-processing-blocks pairs of the plurality of processing blocks, the method further includes: performing a feature reduction on the image feature output from a processing block M1 of the plurality of processing blocks; and performing a feature expansion on the image feature output from a processing block M2 of the plurality of processing blocks; wherein an input end of the processing block M2 is connected directly or indirectly to an output end of the processing block M1.

In some embodiments of the present disclosure, obtaining the image feature output from each of the plurality of processing blocks by performing a feature extraction on the image with the plurality of processing blocks, includes: obtaining a first image feature output from a processing block N1 of the plurality of processing blocks by performing a feature extraction on input of the processing block N1 with the processing block N1, wherein the input of the processing block N1 comprises the image and/or the image feature output from at least one processing block located before the processing block N1, and N1 is equal to or more than one; and obtaining a second image feature output from a next processing block after the processing block N1 by inputting the first image feature into the next processing block.

In some embodiments of the present disclosure, obtaining a second image feature output from a next processing block after the processing block N1 by inputting the first image feature into the next processing block, includes: obtaining the second image feature output from the next processing block by inputting the first image feature together with the image and/or the image feature output from at least one processing block N2 into the next processing block for feature extraction, wherein an input end of the processing block N1 is directly or indirectly connected to an output end of the processing block N2.

In some embodiments of the present disclosure, before inputting the first image feature together with the image and/or the image feature output from at least one processing block N2 into the next processing block for feature extraction, the method further includes: performing a fusion on the image features output from the at least one processing block N2; and inputting an image feature obtained from the fusion into the next processing block after the processing block N1.

In some embodiments of the present disclosure, before obtaining the image feature output from each of the plurality of processing blocks by performing a feature extraction on an image with the plurality of processing blocks, the method further includes: obtaining an initial feature of the image by performing a feature extraction on the image with a convolutional layer; and performing a feature extraction on the image with the plurality of processing blocks includes: inputting the initial feature into the plurality of processing blocks for the feature extraction.

In some embodiments of the present disclosure, the image is a remote sensing image, and the object is land.

In some embodiments of the present disclosure, the method is implemented by a segmentation neural network, the image is a land sample image; and the method further includes: obtaining a segmentation result of a road sample image by processing the road sample image with the segmentation neural network; and adjusting a parameter of the segmentation neural network based on an object prediction result of the land sample image and the segmentation result of the road sample image.

In some embodiments of the present disclosure, the target image feature is obtained based on a mixed feature, which is obtained by batch processing on the land sample image and the road sample image with the segmentation neural network.

In some embodiments of the present disclosure, adjusting the parameter of the segmentation neural network based on the object prediction result of the land sample image and the segmentation result of the road sample image includes: obtaining a first loss based on the object prediction result of the land sample image and label information of the land sample image; obtaining a second loss based on the segmentation result of the road sample image and label information of the road sample image; and adjusting the parameter of the segmentation neural network based on the first loss and the second loss.

In some embodiments of the present disclosure, adjusting the parameter of the segmentation neural network based on the first loss and the second loss includes: obtaining a total loss by performing a weighted summation on the first loss and the second loss; and adjusting the parameter of the segmentation neural network based on the total loss.

In some embodiments of the present disclosure, before obtaining the image feature output from each of the plurality of processing blocks by performing a feature extraction on the image with the plurality of processing blocks, the method further includes: performing, according to a pre-set parameter, at least one of following enhancement on the sample image: adjusting a size of the sample image, rotating an angle of the sample image, and changing brightness of the sample image; and obtaining the image feature output from each of the plurality of processing blocks by performing a feature extraction on the image with the plurality of processing blocks, includes: obtaining the image feature output from each of the plurality of processing blocks by performing a feature extraction on the image subjected to the at least one of enhancement with the plurality of processing blocks.

In some embodiments of the present disclosure, before obtaining the image feature output from each of the plurality of processing blocks by performing a feature extraction on the image with the plurality of processing blocks, the method further includes: obtaining at least one cropped image by cropping the image based on a cropping frame with a pre-set size; and obtaining the image feature output from each of the plurality of processing blocks by performing a feature extraction on the image with the plurality of processing blocks includes: obtaining the image feature output from each of the plurality of processing blocks by performing a feature extraction on the at least one cropped image with the plurality of processing blocks.

According to another aspect of the embodiments of the present disclosure, there is provided an device for segmenting image, including: an image processing module, configured to obtain an image feature output from each of the plurality of processing blocks by performing a feature extraction on the image with a plurality of processing blocks; a fusing module, configured to obtain a target image feature by performing at least two stages of fusion on image features output from at least two adjacent-processing-blocks pairs of the plurality of processing blocks; and a segmenting module, configured to determine an object segmentation result for the image based on the target image feature.

According to another aspect of the present disclosure, a method of training a land segmentation neural network is provided, including: obtaining a predicted segmentation result of the at least one land sample image and a predicted segmentation result of the at least one road sample image by inputting at least one land sample image and at least one road sample image into the land segmentation neural network; and adjusting a parameter of the land segmentation neural network based on the predicted segmentation result of the at least one land sample image and the predicted segmentation result of the at least one road sample image.

In some embodiments of the present disclosure, the land segmentation neural network comprises a plurality of processing blocks connected in sequence, a fusion network, and a segmentation network; and obtaining the predicted segmentation result of the at least one land sample image and the predicted segmentation result of the at least one road sample image by inputting the at least one land sample image and the at least one road sample image into the land segmentation neural network include: obtaining sample image features output from each of the plurality of processing blocks by performing a feature extraction on the at least one land sample image and the at least one road sample image with the plurality of processing blocks; obtaining a target sample image feature by performing at least two stages of fusion on the sample image features output from at least two adjacent-processing-blocks pairs of the plurality of processing blocks with the fusion network; and obtaining the predicted segmentation result of the at least one land sample image and the predicted segmentation result of the at least one road sample image base on the target sample image feature with the segmentation network.

In some embodiments of the present disclosure, obtaining the sample image features output from each of the plurality of processing blocks by performing the feature extraction on the at least one land sample image and the at least one road sample image with the plurality of processing blocks includes: obtaining at least two sample image feature groups of each of at least one the land sample image and at least two sample image feature groups of each of the at least one road sample image by processing each of the at least one land sample image and each of the at least one road sample images with the plurality of processing blocks.

In some embodiments of the present disclosure, obtaining the target sample image feature by performing the at least two stages of fusion on the sample image feature output from the at least two adjacent-processing-blocks pairs of the plurality of processing blocks with the fusion network, includes: obtaining land sample image feature of each of the at least one land sample image by performing at least two stages of fusion on at least two sample image feature groups of each of the at least one land sample image; and obtaining a road sample image feature of each of the at least one road sample image by performing at least two stages of fusion on at least two sample image feature groups of each of the at least one road sample image; wherein the target sample image feature comprises the land sample image feature of the at least one land sample image and the road sample image feature of the at least one road sample image.

In some embodiments of the present disclosure, the land segmentation neural network further comprises a slicing layer; and before obtaining the predicted segmentation result of the at least one land sample image and the predicted segmentation result of the at least one road sample image base on the target sample image feature, the method further includes: separating the land sample image feature and the road sample image feature contained in the target sample image feature from each other with the slicing layer; obtaining the predicted segmentation result of the land sample image by inputting the land sample image feature into the segmentation neural network for processing; and obtaining the predicted segmentation result of the road sample image by inputting the road sample image feature into the segmentation neural network for processing.

In some embodiments of the present disclosure, the land sample image and the road sample image have label information, respectively; and adjusting the parameter of the land segmentation neural network based on the predicted segmentation result of the at least one land sample image and the predicted segmentation result of the at least one road sample image includes: obtaining a first loss based on the predicted segmentation result of the land sample image and the label information of the land sample image; obtaining a second loss based on the predicted segmentation result of the road sample image and the label information of the road sample image; and adjusting the parameter of the land segmentation neural network based on the first loss and the second loss.

In some embodiments of the present disclosure, adjusting the parameter of the land segmentation neural network based on the first loss and the second loss includes: obtaining a total loss by performing a weighted summation on the first loss and the second loss; and adjusting the parameter of the land segmentation neural network based on the total loss.

According to another aspect of the present disclosure, a device for training a land segmentation neural network is provided, including: a result predicting module, configured to obtain a predicted segmentation result of the at least one land sample image and a predicted segmentation result of the at least one road sample image by inputting at least one land sample image and at least one road sample image to the land segmentation neural network; and a parameter adjustment module, configured to adjust a parameter of the land segmentation neural network based on the predicted segmentation result of the at least one land sample image and the predicted segmentation result of the at least one road sample image.

According to another aspect of the present disclosure, there is provided an electronic apparatus including: memory configured to store computer executable instructions; and a processor, configured to communicate with the memory to execute the computer executable instructions so as to implement operations of any one of the methods of segmenting image as mentioned above, or configured to communicate with the memory to execute the executable instruction so as to implement operations of any one of the methods of training the land segmentation neural network as mentioned above.

According to another aspect of the present disclosure, there is provided a computer-readable storage medium configured to store computer-readable instructions, in a case that the instructions are executed, operations of any one of the methods of segmenting image as described above or operations of any one of the methods of training the land segmentation neural network as described above are implemented.

According to another aspect of the present disclosure, a computer program product is provided, which includes computer-readable code, in a case that the computer-readable code is run on an apparatus, a processor of the apparatus is configured to execute instructions for implementing operations of any one of the methods of segmenting image as described above or instructions for implementing operations of any one of the methods of training the land segmentation neural network as described above.

According to another aspect of the present disclosure, another computer program product is provided, configured to store computer-readable instructions, which, upon being executed, cause a computer to perform any one of the methods of segmenting image according to the embodiments of the present disclosure, or to perform any one of the methods of training the land segmentation neural network according to the embodiments of the present disclosure.

In an optional embodiment of the present disclosure, the computer program product is computer storage medium. In another optional embodiment of the present disclosure, the computer program product is a software product, such as SDK.

According to the embodiments of the present disclosure, methods and devices for segmenting image, methods and devices for training land segmentation neural network, electronic apparatus, computer storage media, and computer program products are also provided, wherein image feature output from each of a plurality of processing blocks is obtained by performing a feature extraction on an image with the plurality of processing blocks; a target image feature is obtained by performing at least two stages of fusion on the image feature output from at least two adjacent-processing-blocks pairs of the plurality of processing blocks; and an object segmentation result of the image is determined according to the target image feature.

Based on the methods, devices, the electronic apparatus, the computer storage media, and the computer program products for segmenting object in image, and the methods, devices, the electronic apparatus, the computer storage media and the computer program products for training land segmentation neural network, provided according to the embodiments of the present disclosure, image feature output from each of the plurality of processing blocks is obtained by performing a feature extraction on an image with a plurality of processing blocks; target image feature is obtained by performing at least two stages of fusion on the image feature output from at least two adjacent-processing-blocks pairs of the plurality of processing blocks; and an object segmentation result of the image is determined according to the target image feature. As more information is obtained by performing at least two stages of fusion on the image features output from adjacent processing blocks, the above technical solution benefits to accurate segmentation of object in the image.

The technical solutions of the present disclosure will be further described in detail below through the drawings and embodiments.

### BRIEF DESCRIPTION OF THE DRAWINGS

The figures constituting a part of the specification describe the embodiments of the present disclosure, and together with the description, are used to explain the principle of the present disclosure.

The present disclosure can be understood completely and thoroughly from the detailed description hereinafter with reference to the figures, in which:

FIG. 1 illustrates a schematic flowchart of a method of segmenting image according to an embodiment of the disclosure;

FIG. 2 illustrates an exemplary structural diagram of a processing block of the method of segmenting image according to an embodiment of the disclosure;

FIG. 3 illustrates a schematic diagram of an exemplary structure of a segmentation neural network in a training process of the method of segmenting image according to the embodiment of the disclosure;

FIG. 4 illustrates an exemplary diagram of the comparison of the segmentation effect between the embodiment of the disclosure and the FC-DenseNet;

FIG. 5 illustrates an exemplary diagram of the comparison of the structure segmentation effects of the embodiment of the disclosure, the FC-DenseNet and ClassmateNet;

FIG. 6 illustrates a schematic structural diagram of a device for segmenting image according to an embodiment of the disclosure;

FIG. 7 illustrates an exemplary flow chart of a method of training land segmentation neural network according to an embodiment of the disclosure;

FIG. 8 illustrates a schematic structural diagram of a device for training land segmentation neural network according to an embodiment of the disclosure; and

FIG. 9 illustrates an exemplary schematic structural diagram of an electronic apparatus suitable to implement embodiments of the present disclosure.

### DETAILED DESCRIPTION OF THE EMBODIMENTS

Various exemplary embodiments of the present disclosure will now be described in detail with reference to the accompanying figures. It should be noted that unless specifically stated otherwise, the relative arrangement of components and steps, numerical expressions and numerical values set forth in these embodiments do not limit the scope of the present disclosure.

And meanwhile, it should be understood that, for ease of description, the sizes of the various parts illustrated in the figures are not drawn in scale.

The following description of at least one exemplary embodiment is only illustrative actually, and will never serve as a limit to the disclosure and its application or use.

The technologies, methods, and equipment known to one of ordinary skill in the relevant arts may not be discussed in detail, but where appropriate, the technologies, methods, and equipment should be regarded as a part of the specification.

It should be noted that similar reference numerals and letters in the following drawings indicate similar items, so once a certain item is defined in one figure, it does not need to be further discussed in subsequent figures.

It should be understood that the embodiments of the present disclosure are proposed according to land segmentation of remote sensing images, but can further be applied to other fields, which is not limited in the embodiments of the present disclosure.

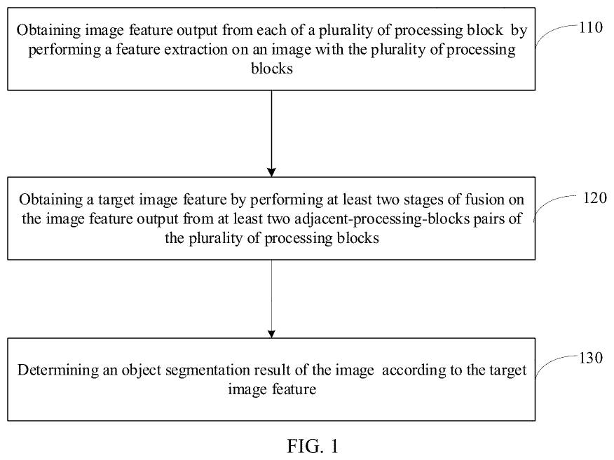

FIG. 1 illustrates a schematic flowchart of a method of segmenting image according to an embodiment of the disclosure. As illustrated in FIG. 1, the method includes:

Step 110: image feature output from each of a plurality of processing block is obtained by performing a feature extraction on an image with the plurality of processing blocks.

Each of the plurality of processing blocks includes at least one processing unit. In some embodiments of the present disclosure, the plurality of processing blocks may be connected in sequence, and the plurality of processing blocks are located at different depths. For example, an output end of one of the plurality of processing blocks may be connected to an input end of a next processing block after the one of the plurality of processing blocks.

The plurality of processing blocks may be configured to perform a feature extraction on the image in sequence. For example, a first processing block of the plurality of processing blocks may perform a feature extraction on an input image so as to obtain image feature output from the first processing block. The second processing block may perform a feature extraction on image feature that is input thereto so as to obtain image feature output from the second processing block. The image feature input into the second processing block may include the image feature output from the first processing block, or may further include the image. And so on, the image feature output from each of the plurality of processing blocks may be obtained.

In some embodiments of the present disclosure, a processing block N1 of the plurality of processing blocks is configured to perform a feature extraction on input of the processing block N1 so as to obtain a first image feature output from the processing block N1, wherein, N1 is an integer greater than or equal to 1.

The first image feature is input into a next processing block after the processing block N1 for feature extraction so as to obtain a second image feature output from the next processing block.

In some embodiments of the present disclosure, the processing block N1 may be a first processing block of the plurality of processing blocks. In such a case, the input of the processing block N1 may be the image or an initial image feature of the image; or, the processing block N1 may be a second processing block of the plurality of processing blocks or a subsequent processing block of the plurality of processing blocks, and in such a case, the input of the processing block N1 may include the image feature output from the preceding processing block, or may further include any image feature output from one or more preceding processing blocks of the processing block N1, or may further include the image. That is, the input of the processing block N1 may include an image and/or the image feature output from one or more preceding processing blocks of the processing block N1. Since the input of the processing block includes image feature with different depths, the image feature output from the processing block may contain more image information.

Image feature obtained from preceding processing blocks has more shallow information, thus, both shallow information and deep information of the image can be obtained in combination with the image feature output from a subsequent processing block.

In some embodiments of the present disclosure, obtaining the second image feature output from the next processing block after the processing block N1 by inputting the first image feature into the next processing block for feature extraction includes: obtaining the second image feature output from the next processing block by inputting the image and/or the image feature output from at least one processing block N2 and the first image feature into the next processing block after the processing block N1 for feature extraction. An input end of the processing block N1 is connected directly or indirectly to an output end of the processing block N2. In the embodiment of the present disclosure, the processing block N1 is located after the processing block N2 in the network structure.

In some embodiments of the present disclosure, input of the next processing block after the processing block N1 may only be the image feature output from processing block N1. For example: the processing block N1 is a third processing block, and the next processing block after the processing block N1 is a fourth processing block, and input of the fourth processing block is image feature output from the third processing block.

In some embodiments of the present disclosure, the input of the next processing block after the processing block N1 includes the image feature output from the processing block N1 and the image feature output from at least one processing block N2. For example, the processing block N1 is a third processing block, the next processing block after the processing block N1 is a fourth processing block, and the at least one processing block N2 includes a first processing block and/or a second processing block. At this time, input of the fourth processing block is image feature output from the third processing block and image feature output from the first processing block, or the image feature output from the third processing block and image feature output from the second processing block, or the image feature output from the third processing block, the image feature output from the first processing block and the image feature output from the second processing block.

In some embodiments of the present disclosure, the input of the next processing block after the processing block N1 includes the image and image feature output from the processing block N1, or, the input of the next processing block after the processing block N1 includes the image, the image feature output from the processing block N1, and the image feature output from at least one processing block N2.

In some embodiments of the present disclosure, in a case that the input of the next processing block after the processing block N1 includes the image feature output from the processing block N1 and the image feature output from the at least one processing block N2, before inputting the image features into the next processing block, part or all of the image features output from the at least one processing block N2 and output from the processing block N1 are fused, and the fused image feature is input into the next processing block after the processing block N1.

When it is necessary to input the image features output from at least two processing blocks into a processing block, the image features may be fused to facilitate processing of the processing block. The fusion can be achieved through bitwise addition (addition by element) or channel-wise stacking or other manners.

In one or more optional embodiments, before inputting the image into the plurality of processing blocks, one or more convolutional layers may be configured to perform a feature extraction on the image so as to obtain an initial feature of the image. Accordingly, the initial feature of the image may be input into the plurality of processing blocks for feature extraction in sequence, which is not limited in the embodiments of the present disclosure.

At this time, the input of the next processing block after the processing block N1 may further include the initial feature of the image. In some embodiments of the present disclosure, assuming that the input of the next processing block after the processing block N1 includes the image and the image feature output from the processing block N1, the initial feature of the image may be fused with the image feature output from the processing block N1. Or, assuming that the input of the next processing block after the processing block N1 includes the image, the image feature output from the processing block N1, and the image feature output from the at least one processing block N2, the initial feature of the image may be fused with the image feature output from the processing block N1 and the image feature output from the at least one processing block N2, and so on, which are not limited in the embodiments of the present disclosure.

Step 120: A target image feature is obtained by performing at least two stages of fusion on the image feature output from at least two adjacent-processing-blocks pairs of the plurality of processing blocks.

In some embodiments of the present disclosure, a first stage fusion is performed on the image feature output from each adjacent-processing-blocks pair, so as to obtain a first fusion feature; a second stage fusion is performed on the first fusion features of at least one adjacent-processing-blocks pair, so as to obtain at least one second fusion feature; and a target image feature is determined according to the at least one second fusion feature.

In the embodiments of the present disclosure, the plurality of processing blocks may be divided into a plurality of adjacent-processing-blocks pairs, and each adjacent-processing-blocks pair includes two adjacent processing blocks (that is, two directly connected processing blocks). In some embodiments of the present disclosure, different adjacent-processing-blocks pairs include different processing blocks, or different adjacent-processing-blocks pairs may not include the same processing block. For example, the first processing block and the second processing block form the first adjacent-processing-blocks pair, the third processing block and the fourth processing block form a second adjacent-processing-blocks pair, and so on.

In some embodiments of the present disclosure, a fusion is performed on the image features output from each adjacent-processing-blocks pair (for example, the image features output by each adjacent-processing-blocks pair are added element by element) so as to achieve fusion of the image features in pair.

Since there are a plurality of adjacent-processing-blocks pairs, a plurality of first fusion feature may be obtained after performing a fusion on the image feature of each adjacent-processing-blocks pair. And meanwhile, a second stage fusion is performed on part or all of the first fusion features (for example, two first fusion features or more than two first fusion features) so as to obtain a second fusion feature which is taken as a target image feature. Or, fusion by adjacent pair is performed on the plurality of first fusion features so as to obtain a plurality of second fusion features. At this time, in some embodiments of the present disclosure, a subsequent feature fusion may be performed on the plurality of second fusion features until a number of subsequent fusion feature obtained from the subsequent fusion is one, and the one subsequent fusion feature is taken as the target image feature.

The subsequent fusion at this time may be to perform fusion by pair on the second fusion features (for example, add two second fusion features element by element), and the subsequent fusion features obtained from the fusion by pair includes at least one or more fusion feature. In a case that the number of the subsequent fusion feature is one, the one subsequent fusion feature is taken as the target image feature; and in a case that the number of subsequent fusion feature is more than one, fusion by pair is continued to be performed on the subsequent fusion features (for example, two subsequent fusion features are added element by element) until the number of subsequent fusion feature obtained from the subsequent fusion is one, and the one subsequent fusion feature is taken as the target image feature. For example, 8 processing blocks are included and for four fusion features are obtained after the first stage fusion, two second fusion features are obtained after the second stage fusion, and a subsequent fusion feature is obtained after third stage fusion, and then, the subsequent fusion feature is taken as the target image feature.

In order to process detailed information further, a dense fusion structure is proposed in the embodiments of this disclosure. Layers of different depths are fused by pair, and the fusion is performed through element-wise summation until fusion is recursively performed on the last layer. The dense fusion structure can enable the network to obtain more information of deep and shallow layers better, which benefits to accurate segmentation in details.

It should be understood that the above description is given by taking performing a fusion by pair and by stage on the processing blocks as an example. In the embodiment of the present disclosure, the fusion may further be performed by stage in units of three or more adjacent processing blocks, which is not limited in the present disclosure.

Step 130: An object segmentation result of the image is determined according to the target image feature.

Based on the method of segmenting image according to the above-mentioned embodiments of the disclosure, the image feature output from each of the plurality of processing blocks is obtained by performing a feature extraction on the image with plurality of processing blocks; the target image feature is obtained by performing at least two stages of fusion on the image feature output from at least two adjacent-processing-blocks pairs of the plurality of processing blocks; and the object segmentation result of the image is obtained according to the target image feature. More information is obtained through at least two stages of fusion on the image features output from adjacent-processing-blocks pairs, which benefits to more accurate segmentation of object in the image.

In some embodiments of the present disclosure, the feature may be a third-order vector, for example, may include a plurality of two-dimensional matrix, or may include a feature graph with at least one channel, the feature graph corresponding to a two-dimensional vector, which is not limited in the embodiment of the present disclosure.

In one or more optional embodiments, each of the plurality of processing blocks may include one or more processing units, each of which may perform a feature extraction on input of the processing block. For example, each processing unit may include one or more convolutional layer. Or, each processing unit further includes additional layers, such as a batch normalization (BN) layer, an activation layer, etc., or any combination thereof. Alternatively, the processing block may further include other units located after the processing unit, such as any one of a resolution reducing layer, a feature scaling layer, a BN layer, and an activating layer, or a combination thereof.

In one or more optional embodiments, the processing unit includes at least one feature extracting layer and a feature adjusting layer;

Step 110 may include: obtaining a first feature by performing a feature extraction on the input of the processing unit with at least one feature extracting layer of the processing unit; and obtaining an image feature output from the processing unit by adjusting the first feature with the feature adjusting layer of the processing unit.

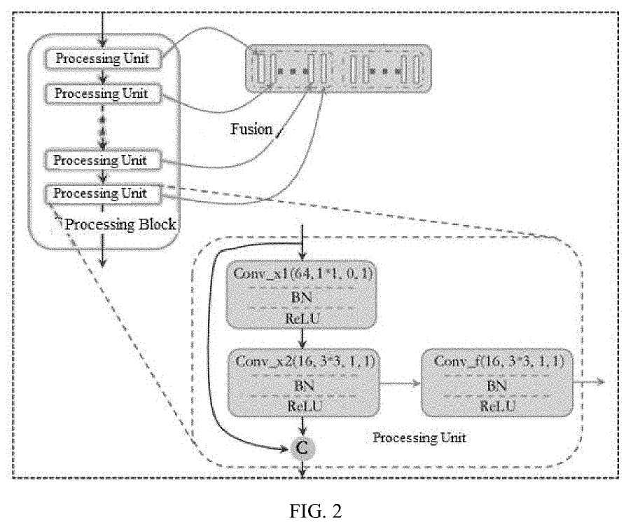

In some embodiments of the present disclosure, the image features output from each adjacent-processing-blocks pair have a same size and a same number of channels. In order to achieve the pair-wise fusion of image features, it is necessary for the image feature output from each adjacent-processing-blocks pair to have the same size and the same number of channels. In the embodiment of the present disclosure, such function is achieved through adding, to the processing unit, a feature adjusting layer configured to adjust the size and the number of channels of the image feature. The feature adjusting layer may be provided in the processing unit or separately, which is not limited in the embodiments of the present disclosure. In an embodiment of the present disclosure, each processing unit may include at least one feature extracting layer (such as: a convolutional layer, a batch normalization layer BN, an activating layer ReLU, etc.) and at least one feature adjusting layer (such as: a convolutional layer, a batch normalization BN layer, and an activating layer ReLU, etc.). FIG. 2 illustrates a schematic structural diagram of a processing block of the method of segmenting image according to an embodiment of the disclosure. As illustrated in FIG. 2, the processing block (Dense Block) includes a plurality of processing units (Layer Unit), each of which includes three convolutional layers, and each convolutional layer is connected to a batch normalization layer (BN) and an activating layer (ReLU), both of which are located after the convolutional layer, wherein the feature graphs output from the first two convolutional layers are input into a next processing unit, and the convolutional layer outputting bypass serves as a feature adjusting layer, and is configured to adjust the size and the number of channels of the feature graph output from the second convolution layer, such that the output feature (such as a feature graph) is same as the feature output from other processing units in the size and the number of channels, so as to be prepared for the fusion of the features.

In some embodiments of the present disclosure, before step 120, the method may further include: performing a feature reduction on the image feature output from the processing block M1 of the plurality of processing blocks; and performing a feature expansion on the image feature output from the processing block M2 of the plurality of processing blocks. An input end of the processing block M2 is connected directly or indirectly to an output end of the processing block M1, or the image feature output from the processing block M2 is obtained on the basis of the image feature output from the processing block M1 at least in part.

In a conventional neural network, the image feature obtained from an upper processing block has less image information due to being subjected to processing of fewer layers, while the image feature obtained from a lower processing block has more image information due to being subjected to processing of more layers. Thus, in some embodiments of the present disclosure, during the pair-wise fusion, and in a case that the image feature output from the adjacent processing blocks is a shallow feature, feature reduction (such as down-sampling) is performed on image feature output from the lower processing block of the adjacent processing blocks, and in a case that the image feature output from the adjacent processing blocks is a deep feature, feature expansion (such as interpolation, which may be bilinear interpolation) is performed on image feature output from an upper processing block of the adjacent processing blocks.

In one or more optional embodiments, the image processed by the method according to the embodiments of the present disclosure may be a remote sensing image. In such a case, the object is land, that is, segmentation of the land in the remote sensing image can be achieved through the method according to the embodiments of the present disclosure, for example, the land in the remote sensing image can be divided into forest, grassland, city, farmland, and etc.

The application scenarios of the method of segmenting image according to the foregoing embodiments of the present disclosure include, but are not limited to: land planning, land use monitoring, land status survey, etc.

In one or more optional embodiments, the method of segmenting image is implemented by a segmentation neural network, and the image is a land sample image.

The method of segmenting image of the embodiment of the present disclosure further includes: training the segmentation neural network based on object segmentation result of the sample image and label information of the sample image.

In order to obtain more accurate image segmentation results, it is necessary to train the segmentation neural network to segment image, such that accuracy of the neural network segmenting specific object (such as land) is improved through training.

In some embodiments of the present disclosure, the sample image is a land sample image; the method according to the embodiment of the present disclosure further includes: obtaining a segmentation result of the road sample image by processing a road sample image with a segmentation neural network; and

adjusting a parameter of the segmentation neural network based on the object prediction result of the land sample image and the segmentation result of the road sample image.

In a case that a land image (such as a remote sensing image) is segmented with a traditional convolution neural network (CNN), structural information of intermediate level is missed. However, the structural information plays an important role in assisting image segmentation and classification. For example, for land cover classification, a remote sensing image covers a large scene, and a scene is restricted and affected by resolution, and at the same time, noise generated by label information may impose a great influence on the image segmentation. Therefore, how to effectively and accurately obtain the structural information of the land image becomes the key to solve the segmentation problem. The segmentation neural network proposed in the embodiments of the present disclosure introduces road data for training, which compensates for the lack of structural information of the land image and improves detailed information.

For a remote sensing image of land cover, due to the large scale of the image, it contains many scenes and is chaotic without smooth borders, and because the land cover itself does not have a clearly quantified boundary, labeling for land cover is ambiguous. It is difficult for traditional CNNs to obtain structural information from a remote sensing image with large scenes, which leads to poor segmentation results. In the embodiments of the present disclosure, it is proposed to take acquired road data as auxiliary data to facilitate training of the network. Because the road data has clear structural characteristics, and there is some road data in the land cover. And the distribution of roads presents different states in different land types. Therefore, based on this idea, a segmentation neural network (for example: Dense Fusion Classmate Network, DFCNet) is used to obtain land information and road information at the same time, such that roads information can be used to assist land classification. As the road data is easier to be obtained with respect to the land cover, and the label information for road is simpler, in practical applications, little land cover data which is more difficult to be labeled, along with part of road data which is easy to be labeled, may be used to assist classification of land cover type.

In some embodiments of the present disclosure, the target image feature is obtained according to a mixed feature, which is obtained by batch processing the land sample image and the road sample image with the segmentation neural network.

After a corresponding target sample image feature set is obtained by processing the obtained sample image set with the segmentation neural network, in order to distinguish the land sample image from the road image, in the embodiments of the present disclosure, a slicing layer, configured to separate target sample feature of the land sample image from target same feature of the road image. The separation is performed according to sequence in which the land sample image and the road image are input.

In some embodiments of the present disclosure, adjusting the parameter of the segmentation neural network based on the object prediction result of the land sample image and the segmentation result of the road sample image, includes: obtaining a first loss based on the object prediction result of the land sample image and the label information of the land sample image; obtaining a second loss based on the segmentation result of the road sample image and the label information of the road sample image; and adjusting the parameter of the segmentation neural network based on the first loss and the second loss.

In some embodiments of the present disclosure, a total loss is obtained by performing a weighted summation on the first loss and the second loss; and the parameter of the segmentation neural network are adjusted according to the total loss. The parameter of the segmentation neural network is adjusted with the weighted summation of the first loss and the second loss. The weight values for the first loss and the second loss may be preset or obtained through experiments or plurality of trainings. Typically, the weight value for the first loss is greater than the weight value for the first loss. For example, a ratio of the weight value for the first loss to the weight value for the second loss is 8:7, and the specific weight value is not limited in this embodiment of the disclosure.

In the embodiment of the present disclosure, road data is adopted to make up for missed structural information in the land classification, which improves the accuracy of the segmentation neural network on segmenting land. Taking advantage of road data which is easily to be obtained and to be standardized, the efficiency and accuracy of land cover classification can be improved through introducing road data for segmentation. And it is further improved to process details.

In one or more optional embodiments, before step 110, the method may further include: performing at least one of following enhancement processing on the sample image according to a pre-set parameter: adjusting a size of the sample image, rotating an angle of the sample image, and changing brightness of the sample image.

Step 110 may include: obtaining the image feature output from each of the plurality of processing blocks by performing a feature extraction on at least one enhanced image with the plurality of processing blocks.

Data enhancement processing is achieved in the embodiments of the present disclosure. Through adjusting at least one of the parameters, more sample images can be obtained, or the display effect of the sample images can be improved, thereby achieving better training effects. For example: a crop size of data for training with the segmentation network is 513×513, value range of random resize (resize) for the road data images is [0.5, 1.5], value range of random resize for the land classification images is [0.8, 1.25]. For road data and land data, range of random rotation is [480,180], and the parameter for adjusting the color jitter is 0.3.

In one or more optional embodiments, before step 110, the method may further include: obtaining at least one cropped image by cropping the image with a cropping frame of a pre-set size.

Step 110 may include: obtaining the image feature output from each of the plurality of processing blocks by performing a feature extraction on the cropped image with the plurality of processing blocks.

In the embodiments of the present disclosure, data is pre-processed so as to obtain more information, and thus, the receptive field of the neural network is enlarged, and whole training process is accelerated. The size of the sample image is decreased through cropping, for example, land data of 2448×2448 is cropped into a size of 1024×1024, and a plurality of sample data is obtained through cropping the land data. In the process of training the neural network, the cropping size of the data for training is increased, which helps the neural network to extract more scene information, thereby improving the effect of segmentation.

In order to process detailed information further, an embodiment of the present disclosure proposes a dense fusion structure, in which layers of different depths are fused in pair. The layers are fused through element-wise sum until the fusion is recursively performed on the last layer. The dense fusion structure can enable the neural network to obtain more deep and shallow information better through the dense fusion structure, which benefits to accurate segmentation in details. And meanwhile, fusion can make back propagation of the neural network to the shallower layer better and faster, which benefits to better supervision of the neural network.

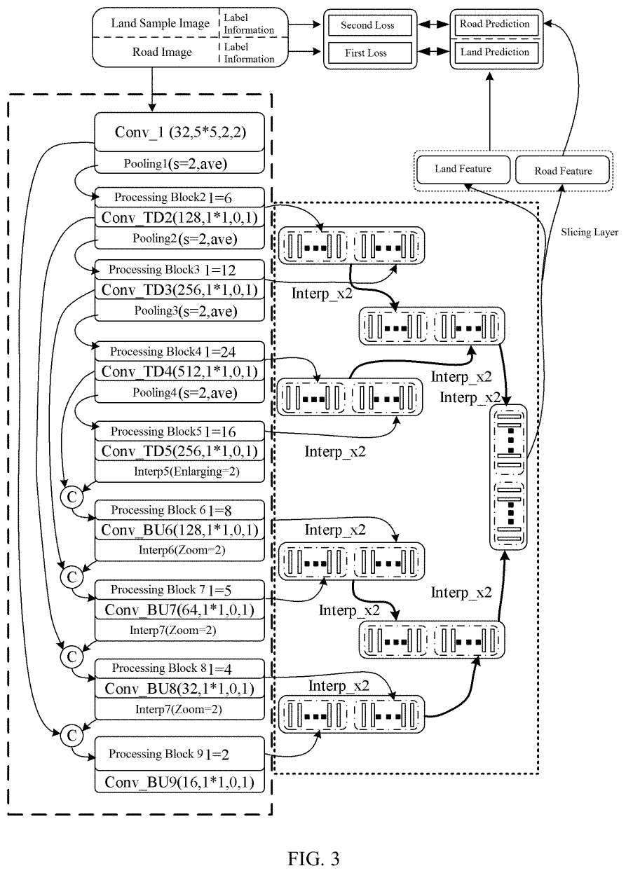

FIG. 3 illustrates a schematic structural diagram of a segmentation neural network in a training process of the method of segmenting image according to the embodiment of the disclosure. As illustrated in FIG. 3, the road data and the sample land data are combined by the concat layer so as to be combined in the 0-th dimension. A structure diagram of the whole segmentation neural network (DFCNet) is illustrated in FIG. 3. The conv1 is a convolutional layer, the Dense Block 2 to the Dense Block 9 are processing blocks which include different numbers of processing units. There are descriptions for parameter in the figures. Taking the Dense Block 2 as an example, l=6 means that the Dense Block 2 includes 6 processing units. Conv_TD indicates a down sampling process, (128, 1*1, 0, 1) indicates that the number of convolution channels is 128, a size of the convolution kernel is 1*1, padding value is 0, and a step size is 1.

Pooling1, Pooling2, Pooling3, and Pooling4 are pooling layers with a strategy of average pooling and with a pooling interval of 2×2. Interp5, Interp6, Interp7, and Interp8 are up-sampling processes in which the features are doubled through bilinear interpolation.

Each Dense Block includes a plurality of processing units Layer Unit, each of which includes two convolutional layers conv_x1/conv_x2 (as illustrated in FIG. 2), followed and connected by a BN layer and an RULU layer respectively. The number of convolution kernels of the convolution layer conv_x1 is 64, and the number of convolution kernels of the convolution layer conv_x2 is 16. The convolution layer conv_2x is followed and connected by a convolutional layer conv_f so as to standardize the features in the feature fusion.

The right part of FIG. 3 illustrates the fusion of features output from different Dense Blocks. A Dense Block with less pixels is followed by an interpolation layer (Interp) and then summed with the Dense Block with more pixels element-wisely. Finally, the last layer is fused, and a slicing layer is added to the last feature fused layer so as to separate the road data from the land data for respective prediction.

The land classification task is compared with a previous classic FC-DenseNet network structure. The feature graph is stored in the deepest layer of the convolutional neural network. FIG. 4 is an exemplary diagram illustrating comparison of segmentation effects of an embodiment of the disclosure and the FC-DenseNet. As illustrated in FIG. 4, (a) illustrates a segmentation result of a traditional FC-DenseNet, and (b) illustrates a segmentation result of the embodiment of the present disclosure. For DFCNet added with road data, it can have better structural information in terms of features, and it can assist segmentation of cities, cultivated land and grassland better.

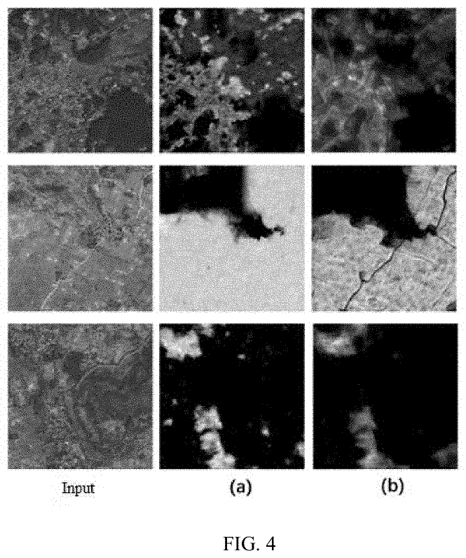

Regarding the segmentation effect, FIG. 5 is an exemplary diagram illustrating comparison of segmentation effects of the embodiments of the present disclosure with the FC-DenseNet and ClassmateNet structure. As illustrated in FIG. 5, (a) illustrates a segmentation result of FC-DenseNet structure, (b) illustrates a segmentation result of ClassmateNet structure, and (c) illustrates a segmentation result of DFCNet structure according to an embodiment of the present disclosure. ClassmateNet without dense fusion structure has better segmentation effect than classic FC-DenseNet, details are further improved by DFCNet with respect to ClassmateNet without dense fusion structure.

One of ordinary skill in the art can understand that all or part of the steps in the above method embodiments can be implemented by program instructions related hardware. The program can be stored in a computer readable storage medium. In a case that the program is executed, operations of the foregoing method embodiment are implemented; and the storage medium includes: a ROM, a RAM, a magnetic disk, or an optical disk and other media that can store program codes.

FIG. 6 illustrates a schematic structural diagram of a device for segmenting image according to an embodiment of the disclosure. The device may be configured to implement the method embodiments of this disclosure as described above. As illustrated in FIG. 6, the device includes:

an image processing module 61, configured to obtain image feature output from each of the plurality of processing blocks by performing a feature extraction on an image with a plurality of processing blocks;

a fusing module 62, configured to obtain target image feature by performing at least two stages of fusion on the image feature output from at least two adjacent-processing-blocks pairs of the plurality of processing blocks; and

a segmenting module 63, configured to determine an object segmentation result of the image according to the target image feature.

The processing block includes at least one processing unit. In some embodiments of the present disclosure, the plurality of processing blocks may be connected in sequence. Here, the plurality of processing blocks may be located at different depths. For example, an output end of any one of the plurality of processing blocks may be connected to an input end of its next processing block.

In some embodiment of the present disclosure, the fusing module 62 is configured to perform a first stage fusion on the image features output from each adjacent-processing-blocks pair so as to obtain a first fusion feature; perform a second step fusion on at least one pair of adjacent first fusion features so as to obtain at least one second fusion feature; and determining a target image feature based on the at least one second fusion feature.

In the embodiment of the present disclosure, the plurality of processing blocks are divided into a plurality of adjacent-processing-blocks pairs, and each adjacent-processing-blocks pair includes two adjacent processing blocks (that is, two directly connected processing blocks). In some embodiments of the present disclosure, different adjacent-processing-blocks pairs include different processing blocks, or different adjacent-processing-blocks pairs may not include a same processing block. For example, the first processing block and the second processing block constitute the first adjacent-processing-blocks pair, the third processing block and the fourth processing block constitute a second adjacent-processing-blocks pair, and so on.

In some embodiments of the present disclosure, the fusing module 62 is configured to perform a subsequent feature fusion on the at least one second fusion feature until a number of subsequent fusion feature obtained from the subsequent feature fusion is one; and the one subsequent fusion feature is taken as target image feature.

In some embodiments of the present disclosure, the fusing module 62 is configured to sum element-wisely the image features output from each adjacent-processing-blocks pair during performing a fusion on the image features output from each adjacent-processing-blocks pair.

In order to process detailed information further, a dense fusion structure is proposed in the embodiments of the present disclosure. Layers of different depths are fused in pair through element-wise sum, until the fusion is recursively performed on the last layer. The segmentation neural network is enabled to obtain more deep information and more shallow information through such a dense fusion structure, which benefits to accurate segmentation in details.

Based on the device for segmenting image according to the foregoing embodiments of the present disclosure, image feature output from each of a plurality of processing blocks is obtained by performing a feature extraction on an image with the plurality of processing blocks; and a target image feature is obtained by performing at least two stages of fusion on the image feature output from at least two adjacent-processing-blocks pairs of the plurality of processing blocks; and the object segmentation result of the image is determined according to the target image feature. More information is obtained through performing at least two stages of fusion on adjacent image feature, which benefits to more accurate segmentation of the object in the image.

In one or more optional embodiments, the plurality of processing blocks are connected in sequence; and/or, the image features output from each adjacent-processing-blocks pair have a same size and a same number of channels. In order to achieve the pair-wise fusion of the image features, it is necessary for the image feature to have the same size and the same number of channels. In the embodiment of the present disclosure, the processing unit is provided with a feature adjusting layer, configured to adjust the size of the feature and the number of the channels so as to achieve such a function. The feature adjusting layer may be provided in the processing unit or separately, which is not limited in the embodiments of the present disclosure. In an embodiment of the present disclosure, each of the processing units may include at least one feature extracting layer (such as a convolutional layer, a batch normalization layer BN, an activating layer ReLU, or the like) and a feature adjusting layer (such as a convolutional layer, a batch normalization layer BN, an activating layer ReLU, or the like).

In one or more optional embodiments of the present disclosure, each of the plurality of processing blocks may include one or more processing units, each of which may perform a feature extraction on input of each of the plurality of processing blocks. For example, each of the one or more processing units may include one or more convolutional layers. Or each of the one or more processing units may further include other layers, such as a batch normalization (BN) layer, an activating layer, or a combination thereof. Alternatively, each of the plurality of processing blocks may further include other units located after the processing unit, such as a resolution reducing layer, a feature scaling layer, a BN layer, an activating layer, or a combination thereof.

In one or more optional embodiments of the present disclosure, the processing unit includes at least one feature extracting layer and a feature adjusting layer.

The image processing module 61 is configured to obtain a first feature by performing a feature extraction on input of the processing unit with the at least one feature extracting layer of the processing unit; and to obtain the image feature output from the processing unit by adjusting the first feature with the feature adjusting layer of the processing unit.

In one or more optional embodiments, the device for segmenting image further includes: a feature image processing module, configured to perform, before obtaining the target image feature by performing at least two stages of fusion on the image features output from at least two adjacent-processing-blocks pairs of the plurality of processing blocks, feature reduction on the image feature output from the processing block M1 of the plurality of processing blocks and feature expansion on the image feature output from the processing block M2 of the plurality of processing blocks; wherein an input end of the processing block M2 is connected directly or indirectly to an output end of the processing block M1, or the image feature output from the processing block M2 is obtained based at least in part on the image feature output from the processing block M1.

In a conventional neural network, the image feature obtained from the upper processing blocks has less image information for being subjected to processing by less processing layers, while the image feature obtained from the lower processing blocks has more image information for being subjected to processing by more processing layers. Therefore, in some embodiments of the present disclosure, in the pair-wise fusion, feature reduction (e.g., down-sampling, etc.) is performed on the image feature output from the lower processing block of the adjacent processing blocks in a case that the image feature of the adjacent processing blocks is a shallow feature; and feature expansion (e.g., interpolation, which may be bilinear interpolation, or the like) is performed on the image feature output from the upper processing block of the adjacent processing blocks in a case that the image processing features of the adjacent processing blocks are deep features.

In one or more optional embodiments, the image processing module 61 is configured to obtain a first image feature of the processing block N1 by performing feature extraction on the input of a processing block N1 with the processing block N1 of the plurality of processing blocks; obtain a second image feature output from a next processing block after the processing block N1 by inputting the first image feature into the next processing block for feature extraction. The input of the processing block N1 includes an image and/or an image feature output from at least one preceding processing block of the processing block N1, and N1 is an integer greater than or equal to 1.

In some embodiments of the present disclosure, the processing block N1 may be a first processing block of the plurality of processing blocks. At this time, the input of the processing block N1 may be an image or an initial feature of an image. Or, the processing block N1 may be a second processing block or a processing block located after the second processing block of the plurality of processing blocks. At this time, the input of the processing block N1 may include an image feature output from the preceding processing block, or may further include an image feature output from any one or more preceding processing blocks located before the processing block, or may further include an image, that is, the input of the processing block N1 may include the image and/or an image feature output from one or more preceding processing blocks of the processing block N1. Since the input of the processing block includes image features of different depths, the image feature output from the processing block may include more image information.

The image feature obtained from a preceding processing block contains more shallow information. In a case of being combined with the image feature output from the subsequent processing blocks, both shallow information and deep information of the image may be obtained.

In some embodiments of the present disclosure, the image processing module 61 is configured to obtain a second image feature output from a next processing block after the processing block N1 by inputting the image and/or the image feature output from the at least one processing block N2 and the first image feature into the next processing block for feature extraction, wherein an input end of the processing block N1 and an output end of the processing block N2 are connected directly or indirectly.

In some embodiments of the present disclosure, the image processing module 61 is further configured to perform, before inputting the image and/or the image feature output from the at least one processing block N2 and the first image feature into the next processing block for feature extraction, fusion on the image features output from the at least one processing block N2 and to input an image feature obtained from the fusion into the next processing block after the processing block N1.

In some embodiments of the present disclosure, the device for segmenting image further includes: a feature extracting module configured to obtain an initial feature of the image by performing a feature extraction on the image with a convolution layer before obtaining image feature output from each processing block of the plurality of processing blocks by performing a feature extraction on the image with the plurality of processing blocks, and to input the initial feature of the image into the plurality of processing blocks for feature extraction.

The image processed by the device for segmenting image according to the embodiments of the present disclosure may be a remote sensing image. In this case, the object is land. That is, the land segmentation is achieved by segmenting the remote sensing image with the device for segmenting image according to the embodiments of the present disclosure. For example, the land of the remote sensing image is segmented into forest and grassland, cities, farming land, etc.

The device for segmenting image according to the foregoing embodiments of the present disclosure may be applied to, but not limited to: land planning, land use monitoring, land status survey, etc.

In one or more optional embodiments, the device for segmenting image according to the embodiments of the present disclosure is implemented by a segmentation neural network, and the image is a land sample image;

The device for segmenting image according to the embodiments of the disclosure further includes: a training module, configured to obtain segmentation result of the road sample image by processing a road sample image with the segmentation neural network, and to adjust a parameter of the segmentation neural network based on an object prediction result and the segmentation result of the road sample image.

In order to obtain more accurate object segmentation results, it is necessary to train the segmentation neural network that achieves image segmentation, and improve the accuracy of segmentation task of an object (for example: land) through training.

In a case that a land image (such as a remote sensing image) is segmented through a conventional Convolutional Neural Networks (CNN), intermediate structure information is missed, and the structural information plays an important role in image segmentation and classification. Thus, how to obtain structural information of the land image effectively and accurately becomes a key to solve the segmentation problem. The segmentation neural network proposed in the embodiments of the present disclosure is trained by introducing road data, which compensates for the missing of structural information of the land image and improves detailed information.

For remote sensing images of land cover, due to the large scale of the images, it contains many scenes and is chaotic without smooth borders. And further, as the land cover itself has no clearly quantified boundary, labeling for land cover is ambiguous. It is difficult for a conventional CNN to obtain structural information from remote sensing images with large scenes, which leads to poor segmentation results. In the embodiments of the present disclosure, it is proposed to take road data as auxiliary data to help training of the network, as the road data has obvious structural feature and there must be some road data in the land cover. And moreover, the distribution of roads presents different states in different land types. Therefore, based on the idea, both the land information and the road information are obtained through a segmented neural network (such as a dense fusion classmate network), so that the road information is used to assist the classification of the land. As the road data is easier to be obtained with respect to the land cover, and label information may be simpler, in practical applications, less land cover data which is difficult to be labeled, along with part of road data which is easy to be labeled, may be used to assist the classification of land cover type.

In some embodiments of the present disclosure, the target image feature is obtained based on a mixed feature, which is obtained by batch processing the land sample image and the road sample image with the segmentation neural network.

In some embodiments of the present disclosure, the training module is configured to obtain a first loss based on the object prediction result of the land sample image and label information of the land sample image; to obtain a second loss based on the segmentation result of the road sample image and label information of the road sample image; and to adjust a parameter of the segmentation neural network based on the first loss and the second loss.

In some embodiments of the present disclosure, the training module is configured to obtain a total loss by performing a weighted summation on the first loss and the second loss, and to adjust the parameter of the segmentation neural network based on the total loss.

In one or more optional embodiments, it may further include: an enhanced image processing module, configured to perform, before obtaining the image feature output from each of the plurality of processing blocks by performing a feature extraction on the image with the plurality of processing blocks, at least one of following enhancement processing on the sample image according to a pre-set parameter: adjusting a size of the sample image, rotating an angle of the sample image, and changing brightness (color jitter) of the sample image; and

an image processing module 61, configured to obtain image feature output from each of a plurality of processing blocks by performing a feature extraction on the image subjected to at least one of the enhanced processing with the plurality of processing blocks.

The embodiments of the present disclosure achieve data enhancement processing, and more sample images may be obtained or display effect of the same image may be improved through adjusting the at least one of the parameters, so as to obtain better training effect. For example: a cropping size of network training data is 513×513, value range of random resizing for road data images is [0.5, 1.5], and value range of random resizing for land classification images is [0.8, 1.25]. For road data and land data, random rotation range is [−180°,180° ], and parameter for adjusting brightness is 0.3.

In one or more optional embodiments of the present disclosure, the device for segmenting image may further include: a preprocessing module, configured to crop, before obtaining the image feature output from each of the plurality of processing blocks by performing a feature extraction on the image with the plurality of processing blocks, the image with a cropping frame of a pre-set size so as to obtain at least one cropped image;

wherein the image processing module 61 is configured to obtain the image feature output from each of the plurality of processing blocks by performing a feature extraction on the cropped image with the plurality of processing blocks.

The embodiments of the present disclosure achieve data preprocessing. In order to obtain more information, to enlarge receptive field of the network, and to accelerate the whole training process, the size of the sample image may be reduced by cropping, for example: cropping land data of 2448×2448 into a size of 1024×1024. At this time, a plurality of pieces of sample data may be obtained by cropping a piece of land data. The cropping size of the training data is increased in the processing of training the network, which helps the network to extract more information on scene, thereby improving the effect of segmentation.

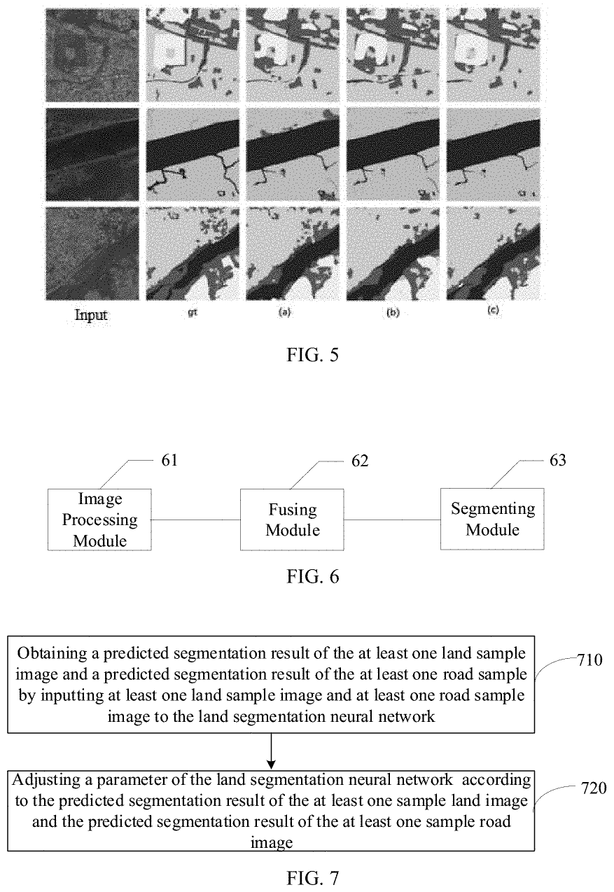

FIG. 7 illustrates an exemplary flow chart of a method of training land segmentation neural network according to an embodiment of the disclosure. As illustrated in FIG. 7, the method includes:

Step 710: a predicted segmentation result of the at least one land sample image and a predicted segmentation result of the at least one road sample image are obtained by inputting at least one land sample image and at least one road sample image into the land segmentation neural network; and

Step 720: a parameter of the land segmentation neural network is adjusted according to the predicted segmentation result of the at least one sample land image and the predicted segmentation result of the at least one sample road image.

For land images, they usually have a large size, contain many scenes and are disordered and have no smooth boundary. And further, as land cover itself does not have a clearly quantified boundary, labeling for land cover is ambiguous. It is difficult for conventional CNNs to obtain structural information from land images with large scenes, resulting in poor segmentation results.

In the embodiments of the present disclosure, it is proposed to use road data along with label information as auxiliary data to help training the land segmentation neural network. Based on this idea, as the road data has clear structural features, there is some road data in the land image, and the distribution of roads presents different states in different land types, a land segmentation neural network (such as a densely fusion classmate network) is adopted to obtain land information and road information at the same time, so that the road information assists classification of the land. As road data is easier to be obtained with respect to land cover, and the label information for the road is simpler with respect to the label information for the land cover, in practical applications, less land cover data which is difficult to be labeled, along with part of road data which is easy to be labeled, is used to assist the classification of the land cover.

In a case that an image to which the method of segmenting object of the image illustrated in FIG. 1 is applied is a remote sensing image and the object is land, the land segmentation neural network trained by the embodiments of the present disclosure may be applied to the method of segmenting image as illustrated in FIG. 1 so as to achieve segmentation of the land in the remote sensing image to obtain a land segmentation result.

In one or more optional embodiments of the present disclosure, the land segmenting neural network includes a plurality of processing blocks connected in sequence, a fusion network, and a segmentation network;

Step 710 may include: obtaining sample image feature output from each of the plurality of processing blocks by performing a feature extraction on at least one land sample image and at least one road sample image with a plurality of processing blocks; obtaining a target sample image feature by performing at least two stages of fusion on the sample image feature output from at least two adjacent-processing-blocks pairs of the plurality of processing blocks with the fusion network; and obtaining predicted segmentation result of the at least one land sample image and predicted segmentation result of the at least one road sample image with the segmenting network based on the target sample image feature.

In order to further process detailed information, the embodiments of the present disclosure proposes a dense fusion structure, in which layers located at different depths are fused pair-wisely through element-wise sum until the last layer is recursively fused. The dense fusion structure can enable the network to obtain more deep and shallow information better, which benefits to accurate segmentation in details. At the same time, the fusion can make back propagation of the network to shallower layers better and faster, which benefits to supervision of the network better.

In some embodiments of the present disclosure, at least two sample image feature groups for each of the at least one land sample image and at least two sample image feature groups for each of the at least one road sample image are obtained by processing each of the at least one land sample image and each of the at least one road sample image with the plurality of processing blocks.

At least two sample image feature groups are obtained by processing each of the at least one land sample image with the plurality of processing blocks, wherein the at least two sample image feature groups may correspond to at least two processing blocks, for example, the at least two sample image feature groups contains the sample image feature output from each of the plurality of processing blocks, or the at least two sample image feature groups contains the sample image feature output from a part of the plurality of processing blocks, which is not limited in the embodiments of the present disclosure.

In the embodiments of the present disclosure, the land segmentation neural network processes each input land sample image and each input road sample image separately so as to prevent mixing of image feature between different sample images during batch processing, which leads to inaccurate training results.

In some embodiments of the present disclosure, obtaining the target sample image feature by performing at least two stages of fusion on the sample image feature output from at least two adjacent-processing-blocks pairs of the plurality of processing blocks includes: obtaining the land sample image feature of each land sample image by performing at least two stages of fusion on at least two sample image feature groups of each land sample image; obtaining the road sample image feature of each road sample image by performing at least two stages of fusion on the at least two sample image feature groups of each road sample image, wherein the target sample image feature includes the land sample image feature of the at least one land sample image and the road sample image feature of the at least one road sample image.

Each image sample image and each road sample image have different image features, and fusion of the image features of different sample images cause inaccurate training result. In the embodiments of the present disclosure, the land segmentation neural network performs fusion on the two sample image features of each sample image (the land sample image or the road sample image) respectively, so as to prevent sample image features of multiple sample images from being fused.

In some embodiments of the present disclosure, the land segmentation neural network further includes a slicing layer; before determining the predicted segmentation result of the at least one land sample image and the predicted segmentation result of the at least one road sample image based on the target sample image feature, the method of training the land segmentation neural network further includes:

separating the land sample image feature and the road sample image feature contained in the target sample image feature from each other with the slicing layer; obtaining the predicted segmentation result of the land sample image by inputting the land sample image feature into the land segmentation neural network for processing, and obtaining the predicted segmentation result of the road sample image by inputting the road sample image feature into the land segmentation neural network for processing.

In the embodiments of the present disclosure, after obtaining respective target sample image feature set by processing the at least one land sample image and the at least one road sample image with the plurality of processing blocks of the land segmentation neural network which are connected in sequence, in order to separate the land sample image and the road sample image such that the land segmentation neural network is trained with information of the road image, the slicing layer is configured to separate the target sample image feature of the land sample image from the target sample image feature of the road sample image. For example, the information can be separated from each other according to a sequence in which the land sample image and the road sample image are inputted.

In some embodiments of the present disclosure, the land sample image and the road sample image have label information respectively;

adjusting the parameter of the land segmentation neural network based on the predicted segmentation result of the at least one land sample image and the predicted segmentation result of the at least one road sample image includes: obtaining a first loss based on the predicted segmentation result of the land sample image and the label information of the land sample image, obtaining a second loss based on the predicted segmentation result of the road sample image and the label information of the road sample image; and adjusting the parameter of the land segmentation neural network based on the first loss and the second loss.

In some embodiments of the present disclosure, a total loss is obtained by performing weighted summation on the first loss and the second loss, and the parameter of the land segmentation neural network is adjusted based on the total loss. The parameter of the land segmentation neural network is adjusted with the weighted summation of the first loss and the second loss. The weight values for the weighted sum can be preset or obtained through experiments or a plurality of trainings. Typically, the weight value for the first loss is greater than the weight value for the second loss, for example: the ratio of the weight value for the first loss to the weight value for the second loss is 8:7, and the specific weight value is not limited in the embodiments of the disclosure.

In the embodiments of the present disclosure, road data is used to compensate for missing of structural information of land classification, such that the accuracy of land segmentation tasks by the land segmentation neural network is improved. Efficiency and accuracy of land cover classification can be improved through introducing road data, which is easy to be obtained and to be standardized, for segmentation. And processing on details is getting better.

An example of training process for the land segmentation neural network according to the disclosure may be illustrated in FIG. 3, and the comparison between the segmentation effect achieved by the land segmentation neural network and the segmentation effect of FC-DenseNet may be illustrated in FIG. 4. The comparison between the segmentation effect achieved by the land segmentation neural network and the segmentation effect of FC-DenseNet and between the segmentation effect achieved by the land segmentation neural network and the segmentation effect of ClassmateNet may be illustrated in FIG. 5.

In practical applications, as road data is relatively simple, it is easier to be obtained than land cover images in terms of labeling and acquisition. Therefore, introduction of simple road data can greatly improve the classification of land cover images that are more difficult to be obtained and more difficult to be labeled, which can save manpower for standardization. And introduction of the dense fusion model network structure can benefit to the classification of land cover in detail.

One of ordinary skill in the art can understand that all or part of the steps in the above method embodiments can be implemented by hardware relevant to instructions of program. The program may be stored in a computer readable storage medium. When the program is executed, operations of the steps of the foregoing method embodiment are implemented; and the storage medium includes: ROM, RAM, a magnetic disk, or an optical disk and other media that can store program codes.

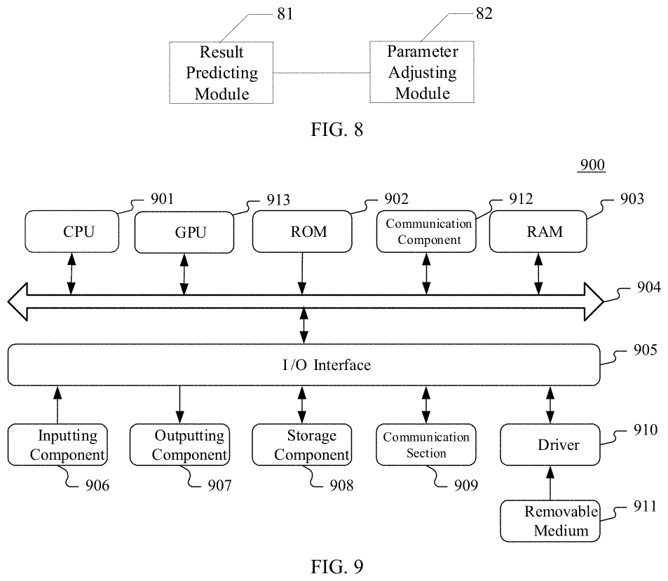

FIG. 8 illustrates a schematic structural diagram of a device for training a land segmentation neural network according to an embodiment of the disclosure. The device may be configured to implement the foregoing method embodiments of this disclosure. As illustrated in FIG. 8, the device includes:

a result predicting module 81, configured to obtain a predicted segmentation result of the at least one land sample image and a predicted segmentation result of the at least one road sample image by inputting at least one land sample image and at least one road sample image into the land segmentation neural network.

a parameter adjusting module 82, configured to adjust a parameter of the land segmentation neural network based on the predicted segmentation result of the at least one land sample image and the predicted segmentation result of the at least one road sample image.

Regarding the land images, they usually have a large scale, contain many scenes and are disordered without smooth borders, and further, as the land cover itself does not have a clearly quantified boundary, labeling for land cover may be ambiguous. It is difficult for conventional CNNs to obtain structural information from land images with large scenes, resulting in poor segmentation results.

In the embodiments of the present disclosure, it is proposed to use road data with label information as auxiliary data to assist training the land segmentation neural network. Based on this idea, as the road data has structural features, and as there is some road data in the land image and the distribution of roads presents different states in different land types, a land segmentation neural network (such as a densely integrated classmate network) is configured to obtain land information and road information simultaneously, so that the road information may assist classification of land. As the road data is easier to be obtained than the land cover, and the labeling is be simpler, in practical applications, less land cover data which is more difficult to be labeled, along with a part of road data which is easier to be labeled, is used to facilitate classification of land cover type.

In one or more optional embodiments, the land segmentation neural network includes a plurality of processing blocks connected in sequence, a fusion network, and a segmenting network;

a result predicting module 81 is configured to: obtain sample image feature output from each of a plurality of processing blocks through performing a feature extraction on at least one land sample image and at least one road sample image with the plurality of processing blocks; obtain a target sample image feature by performing at least two stages of fusion on the sample image feature output from at least two adjacent-processing-blocks pairs of the plurality of processing blocks with the fusion network; and obtain predicted segmentation result of the at least one land sample image and predicted segmentation result of the at least one road sample image with the segmenting network.

In order to further process the detailed information, an embodiment of the present disclosure proposes a dense fusion structure, in which layers of different depths are fused pair-wisely through element-wise sum until the last layer is recursively fused. The dense fusion structure can enable the network to obtain more deep and shallow information better, which benefits to accurate segmentation in details. At the same time, the fusion can make back propagation of the network to shallower layers better and faster, which benefits to supervision of the network better.

In some embodiments of the present disclosure, the result predicting module 81 is configured to obtain at least two sample image feature groups of each of the at least one land sample image and at least two sample image feature groups of each of the at least one road sample image by processing each of the at least two land sample image and each of the at least two road sample image with the plurality of processing blocks.

In some embodiments of the present disclosure, the result predicting module 81 is configured to obtain land sample image feature for each of the at least one land sample image by performing at least two stages of fusion on at least two sample image feature groups for each of the at least one land sample image, and to obtain road sample image feature of each of the at least one road sample image by performing at least two stages of fusion on at least two sample image features of each of the at least one road sample image, wherein the target sample image feature includes the land sample image feature of the at least one land sample image and the road sample image feature of the at least one road sample image.

In some embodiments of the present disclosure, the land segmentation neural network further includes a slicing layer;

The result predicting module 81 is further configured to separate the land sample image feature and the road sample image feature contained in the target sample image feature from each other with the slicing layer before determining the predicted segmentation result of the at least one land sample image and the predicted segmentation result of the at least one road sample image based on the target sample image feature; to obtain the predicted segmentation result by inputting the land sample image feature into the segmentation network for processing; and to obtain the predicted segmentation result of the road sample image by inputting the road sample image feature into the segmentation network for processing.

In some embodiments of the present disclosure, the land sample image and the road sample image have label information, respectively; and the parameter adjusting module 82 is configured to: obtain a first loss based on the predicted segmentation result of the land sample image and the label information of the land sample image; obtain a second loss based on the prediction segmentation result of the road sample image and the label information of the road sample image; and adjust the parameter of the land segmentation neural network based on the first loss and the second loss.

In some embodiments of the present disclosure, the parameter adjusting module 82 is configured to obtain a total loss by performing a weighted summation on the first loss and the second loss; and to adjust the parameter of the land segmentation neural network according to the total loss.

According to another aspect of the embodiments of the present disclosure, there is provided an electronic apparatus including a processor which includes any one of the device for segmenting image as described above or any one of the devices for training the land segmentation neural network as described above.

According to another aspect of the embodiments of the present disclosure, there is provided an electronic apparatus, including: memory configured to store executable instructions;

and a processor, configured to communicate with the memory to execute the executable instructions so as implement operations of any one of the methods of segmenting image as described above, or configured to communicate with the memory to execute the executable instructions so as to implement operations of any one of the methods of training land segmentation neural network as described above.

According to another aspect of the embodiments of the present disclosure, there is provided a computer-readable storage medium configured to store instructions readable by a computer, in a case that the instructions are executed, operations of any one of the methods of segmenting image described above or operations of any one of the methods of training land segmentation neural network described above are implemented.

According to another aspect of the embodiments of the present disclosure, a computer program product is provided, which includes computer-readable code, in a case that the computer-readable code is run on an apparatus, a processor of the apparatus is configured to implement operations of any one of the methods of segmenting image as described above or operations of any one of the methods of training land segmentation neural network as described above.

In one or more optional implementations, the embodiments of the present disclosure further provide a computer program product configured to store computer-readable instructions, which, upon execution, cause a computer to implement operations of any one of the methods of segmenting image as described or operations of any one of the methods of training land segmentation neural network as described above.

The computer program product can be implemented by hardware, software or a combination thereof. In an optional embodiment, the computer program product is implemented as a computer storage medium. In another optional embodiment, the computer program product is implemented as a software product, such as a software development kit (SDK), and so on.

According to the embodiments of the present disclosure, a method and a device for segmenting image, a method and a device for training land segmentation neural network, electronic apparatus, computer storage media, and a computer program product are further provided, wherein image feature output from each of a plurality of processing blocks is obtained by performing a feature extraction on the image with the plurality of processing blocks; a target image feature is obtained by performing at least two stages of fusion on the image feature output from at least two pairs of processing blocks of the plurality of processing blocks; and object segmentation result of the image is determined according to the target image feature.

In some embodiments, the target tracking instruction may specifically be a calling instruction, and the first device may instruct the second device to perform target tracking by calling. Accordingly, in response to receiving the calling instruction, the second device may implement steps and/or processes the method of tracking target according to any embodiment.

It should be understood that the terms such as “first” and “second” in the embodiments of the present disclosure are intended for distinguishing purposes only, and should not be construed as a limit to the embodiments of the present disclosure.

It should also be understood that in the present disclosure, the term “plurality” may refer to two or more than two, and the term “at least one” may refer to one, two or more than two.

It should also be understood that any component, data, or structure mentioned in this disclosure may typically be understood as one or more unless it is clearly defined or the context suggests opposite enlightenment.

It should also be understood that the description of the various embodiments in this disclosure focuses the differences between the various embodiments, and the same or similarities may be referred to each other, and for the sake of brevity, the details are not elaborated.

The embodiment of the present disclosure further provides an electronic apparatus, which, for example, may be a mobile terminal, a personal computer (PC), a tablet computer, a server, etc. Next, referring to FIG. 9, it illustrates a schematic structural diagram of an example of an electronic apparatus 900 applicable to implement the embodiments of the present disclosure. As illustrated in FIG. 9, the electronic apparatus 900 includes one or more processors, and a communication component, etc. The one or more processors may be, for example: one or more central processing units (CPU) 901, and/or one or more graphics processing units (GPU) 913, etc. The processors may perform various appropriate actions and processing according to executable instructions stored in a read-only memory (ROM) 902 or executable instructions loaded to the random-access memory (RAM) 903 from the storage component 908. The communication component 912 may include but is not limited to a network card, which may include but is not limited to an IB (Infiniband) network card.

The processor may communicate with a read-only memory 902 and/or a random-access memory 903 to execute executable instructions. The processor may be connected to the communication component 912 via a bus 904, and may communicate with other target devices via the communication component 912, thereby implementing operations for any one of the methods according to the embodiments of the present disclosure, for example, obtaining an image feature output from each of the plurality of processing blocks by performing a feature extraction on an image with a plurality of processing blocks; obtaining a target image feature by performing at least two stages of fusion on the image feature output from at least two adjacent-processing-blocks pairs of the plurality of processing blocks; and obtaining an object segmentation result of the image based on the target image feature.

In addition, in the RAM 903, various programs and data for operation of the device may further be stored. The CPU 901, the ROM 902, and the RAM 903 are connected to each other through a bus 904. In the case that there is a RAM 903, the ROM 902 is an optional module. The RAM 903 stores executable instructions, or writes executable instructions to the ROM 902 in operation, and the executable instructions cause the central processing unit 901 to perform operations corresponding to the methods. An input/output (I/O) interface 905 is further connected to the bus 904. The communication component 912 may be integrated, or may be configured to have a plurality of sub-modules (for example, a plurality of IB network cards) and be linked to the bus.

The following components are connected to the I/O interface 905: an inputting component 906 including a keyboard, a mouse, and the like; an outputting component 907 including a cathode ray tube (CRT), a liquid crystal display (LCD) and the like, and a speaker and the like; a storage component 908 including a hard disk and the like; and a communication section 909 including a network interface card such as a LAN card, a modem, and the like. The communication section 909 performs communication processing via a network such as the Internet. A driver 910 is further connected to the I/O interface 905 as needed. A removable medium 911, such as a magnetic disk, an optical disk, a magneto-optical disk, a semiconductor memory and the like, is installed on the driver 910 as needed, so that a computer program read from it is installed into the storage component 908 as needed.

It should be noted that the architecture illustrated in FIG. 9 is just an optional implementation. In practice implementation, the number and types of the components in FIG. 9 can be selected, deleted, added or replaced according to actual requirements. Various functional components may be integrated or provided separately. For example, the GPU 913 and the CPU 901 may be provided separately or the GPU 913 may be integrated on the CPU 901, the communication component may be provided separately or integrated on the CPU 901 or the GPU 913, and so on. These alternative implementations all fall into the protection scope disclosed in this disclosure.

In particular, according to the embodiments of the present disclosure, the process described above with reference to the flowchart may be implemented as a computer software program. For example, the embodiments of the present disclosure include a computer program product, which includes a computer program tangibly contained on a machine-readable medium. The computer program includes program code for performing the method illustrated in the flowchart. The program code may include instructions for implementing operations of the method according to the embodiments of present disclosure, for example, obtaining an image feature output from each of a plurality of processing blocks by performing a feature extraction on the image with the plurality of processing blocks; obtaining an target image feature through performing at least two stages of fusion on the image feature output from at least two pairs of processing blocks of the plurality of processing blocks; and determining an object segmentation result of the image according to the target image feature. In such embodiments, the computer program may be downloaded from a network via the communication section 909 and installed, and/or installed from the removable medium 911. In the case that the computer program is executed by the CPU 901, operations of the functions defined in the methods according to the embodiments of the present disclosure are implemented.

The methods and the apparatus according to the present disclosure may be implemented in various ways. For example, the method and the apparatus of the present disclosure may be implemented by software, hardware, firmware or any combination of software, hardware, and firmware. The above-mentioned order of the steps for the method is only for illustration, and the steps of the methods of the present disclosure are not limited to the order specifically described above, unless otherwise clearly stated. In addition, in some embodiments, the present disclosure can further be implemented as a program recorded in a recording medium, and these programs include machine-readable instructions for implementing operations of the method according to the present disclosure. Thus, the present disclosure further covers a recording medium storing a program for performing the method according to the present disclosure.

The description of the disclosure is given for the sake of illustration and description, and is not exhaustive or limits the disclosure to what is disclosed. Many modifications and variants are obvious to one of ordinary skill in the art. The embodiments are selected and described in order to better illustrate the principles and practical applications of the present disclosure, and to enable one of ordinary skill in the art to understand the present disclosure so as to design various embodiments with various modifications suitable for specific purposes.

1. A method of segmenting image, comprising:
obtaining an image feature output from each of a plurality of processing blocks by performing a feature extraction on an image with the plurality of processing blocks;
obtaining a target image feature by performing at least two stages of fusion on the image features output from at least two adjacent-processing-blocks pairs of the plurality of processing blocks; and
determining a segmentation result for an object in the image according to the target image feature.

2. The method according to claim 1, wherein obtaining the target image feature by performing at least two stages of fusion on the image features output from at least two adjacent-processing-blocks pairs of the plurality of processing blocks, comprises:
obtaining first fusion features by performing a first-stage fusion on the image features output from each of the adjacent-processing-blocks pairs;
obtaining one or more second fusion features by performing a second-stage fusion on at least one adjacent-first-fusion-features pair of the first fusion features; and
determining the target image feature according to the one or more second fusion features.

3. The method according to claim 2, wherein determining the target image feature according to the one or more second fusion features comprises:
performing a subsequent fusion on the one or more second fusion features until a number of subsequent fusion feature obtained from the subsequent fusion is one; and
taking the one subsequent fusion feature as the target image feature.

4. The method according to claim 2, wherein the image features output from each adjacent-processing-blocks pair are added element-wisely during performing a fusion on the image features output from each adjacent-processing-blocks pair.

5. The method according to claim 1, wherein:
the plurality of processing blocks are connected in sequence; and/or,
the image features output from each adjacent-processing-blocks pair have a same size and a same number of channels.

6. The method according to claim 1, wherein:
each of the plurality of processing blocks comprises at least one processing unit, each of which comprises at least one feature extracting layer and at least one feature adjusting layer; and
obtaining the image feature output from each of the plurality of processing blocks by performing a feature extraction on the image with the plurality of processing blocks, comprises:
obtaining a first feature by performing a feature extraction on input of the processing block with the at least one feature extracting layer of the processing block; and
obtaining the image feature output from the processing block by performing an adjustment on the first feature with the feature adjusting layer of the processing block.

7. The method according to claim 1, wherein, before obtaining a target image feature by performing at least two stages of fusion on the image features output from at least two adjacent-processing-blocks pairs of the plurality of processing blocks, the method further comprises:
performing a feature reduction on the image feature output from a processing block M1 of the plurality of processing blocks; and
performing a feature expansion on the image feature output from a processing block M2 of the plurality of processing blocks;
wherein an input end of the processing block M2 is connected directly or indirectly to an output end of the processing block M1.

8. The method according to claim 1, wherein obtaining the image feature output from each of the plurality of processing blocks by performing a feature extraction on the image with the plurality of processing blocks, comprises:
obtaining a first image feature output from a processing block N1 of the plurality of processing blocks by performing a feature extraction on input of the processing block N1 with the processing block N1, wherein the input of the processing block N1 comprises the image and/or the image feature output from at least one processing block located before the processing block N1, and N1 is equal to or more than one; and
obtaining the second image feature output from the next processing block by inputting the first image feature together with the image and/or the image feature output from at least one processing block N2 into the next processing block for feature extraction, wherein an input end of the processing block N1 is directly or indirectly connected to an output end of the processing block N2.

9. The method according to claim 8, wherein, before inputting the first image feature together with the image and/or the image feature output from at least one processing block N2 into the next processing block for feature extraction, the method further comprises:
performing a fusion on the image features output from the at least one processing block N2; and
inputting an image feature obtained from the fusion into the next processing block after the processing block N1.

10. The method according to claim 1, wherein:
before obtaining the image feature output from each of the plurality of processing blocks by performing a feature extraction on an image with the plurality of processing blocks, the method further comprises:
obtaining an initial feature of the image by performing a feature extraction on the image with a convolutional layer; and
performing a feature extraction on the image with the plurality of processing blocks comprises:
inputting the initial feature into the plurality of processing blocks for the feature extraction.

11. The method according to claim 1, wherein
the image is a remote sensing image, and
the object is land.

12. The method according to claim 1, wherein the method is implemented by a segmentation neural network, the image is a land sample image, the target image feature is obtained based on a mixed feature, which is obtained by batch processing the land sample image and the road sample image with the segmentation neural network, and the method further comprises:
obtaining a segmentation result of a road sample image by processing the road sample image with the segmentation neural network;
obtaining a first loss based on the object prediction result of the land sample image and label information of the land sample image;
obtaining a second loss based on the segmentation result of the road sample image and label information of the road sample image;
obtaining a total loss by performing a weighted summation on the first loss and the second loss; and
adjusting the parameter of the segmentation neural network based on the total loss.

13. The method according to claim 12, wherein:
before obtaining the image feature output from each of the plurality of processing blocks by performing a feature extraction on an image with the plurality of processing blocks, the method further comprises:
performing, according to a pre-set parameter, at least one of following enhancement on the sample image:
adjusting a size of the sample image,
rotating an angle of the sample image, and
changing brightness of the sample image; and
obtaining the image feature output from each of the plurality of processing blocks by performing a feature extraction on an image with the plurality of processing blocks comprises:
obtaining the image feature output from each of the plurality of processing blocks by performing a feature extraction on the image subjected to the at least one of enhancement with the plurality of processing blocks.

14. The method according to claim 1, wherein:
before obtaining the image feature output from each of the plurality of processing blocks by performing a feature extraction on the image with the plurality of processing blocks, the method further comprises:
cropping the image based on a cropping frame with a pre-set size so as to obtain at least one cropped image; and
obtaining the image feature output from each of the plurality of processing blocks by performing a feature extraction on the image with the plurality of processing blocks comprises:
obtaining the image feature output from each of the plurality of processing blocks by performing a feature extraction on the at least one cropped image with the plurality of processing blocks.

15. A method of training a land segmentation neural network, comprising:
obtaining a predicted segmentation result of the at least one land sample image and a predicted segmentation result of the at least one road sample image by inputting at least one land sample image and at least one road sample image into the land segmentation neural network; and
adjusting a parameter of the land segmentation neural network based on the predicted segmentation result of the at least one land sample image and the predicted segmentation result of the at least one road sample image.

16. The method according to claim 15, wherein:
the land segmentation neural network comprises a plurality of processing blocks connected in sequence, a fusion network, and a segmentation network; and
obtaining the predicted segmentation result of the at least one land sample image and the predicted segmentation result of the at least one road sample image by inputting the at least one land sample image and the at least one road sample image into the land segmentation neural network comprises:
obtaining sample image features output from each of the plurality of processing blocks by performing a feature extraction on the at least one land sample image and the at least one road sample image with the plurality of processing blocks;
obtaining a target sample image feature by performing at least two stages of fusion on the sample image features output from at least two adjacent-processing-blocks pairs of the plurality of processing blocks with the fusion network; and
obtaining the predicted segmentation result of the at least one land sample image and the predicted segmentation result of the at least one road sample image base on the target sample image feature with the segmentation network.

17. The method according to claim 16,
wherein obtaining sample image features output from each of the plurality of processing blocks by performing a feature extraction on the at least one land sample image and the at least one road sample image with the plurality of processing blocks comprises:
obtaining at least two sample image feature groups of each of at least one the land sample image and at least two sample image feature groups of each of the at least one road sample image by processing each of the at least one land sample image and each of the at least one road sample images with the plurality of processing blocks; and
wherein obtaining the target sample image feature by performing the at least two stages of fusion on the sample image features output from the at least two adjacent-processing-blocks pairs of the plurality of processing blocks with the fusion network, comprises:
obtaining a land sample image feature of each of the at least one land sample image by performing at least two stages of fusion on at least two sample image feature groups of each of the at least one land sample image; and
obtaining road sample image feature of each of the at least one road sample image by performing at least two stages of fusion on at least two sample image feature groups of each of the at least one road sample image;
wherein the target sample image feature comprises the land sample image feature of the at least one land sample image and the road sample image feature of the at least one road sample image.

18. The method according to claim 16, wherein:
the land segmentation neural network further comprises a slicing layer; and
before obtaining the predicted segmentation result of the at least one land sample image and the predicted segmentation result of the at least one road sample image base on the target sample image feature, the method further comprises:
separating the land sample image feature from the road sample image feature contained in the target sample image feature with the slicing layer;
obtaining the predicted segmentation result of the land sample image by inputting the land sample image feature into the segmentation neural network for processing; and
obtaining the predicted segmentation result of the road sample image by inputting the road sample image feature into the segmentation neural network for processing.

19. The method according to claim 18, wherein:
the land sample image and the road sample image have label information, respectively; and
adjusting the parameter of the land segmentation neural network based on the predicted segmentation result of the at least one land sample image and the predicted segmentation result of the at least one road sample image comprises:
obtaining a first loss based on the predicted segmentation result of the land sample image and the label information of the land sample image;
obtaining a second loss based on the predicted segmentation result of the road sample image and the label information of the road sample image;
obtaining a total loss by performing a weighted summation on the first loss and the second loss; and
adjusting the parameter of the land segmentation neural network based on the total loss.

20. An electronic apparatus, comprising: memory configured to store computer executable instructions;
and a processor, configured to communicate with the memory to execute the computer executable instructions so as to implement operations of the method of segmenting image according to claim 1.
